(19) United States
(12) Patent Application Publication
(10) Pub. No.: US 2025/0282614 A1
(43) Pub. Date: Sep. 11, 2025

(54) PROCESS FOR CRACKING AMMONIA

(71) Applicant: JOHNSON MATTHEY PUBLIC LIMITED COMPANY, London (GB)

(72) Inventors: Julie Louise ASHCROFT, Royston (GB); John David PACH, Billingham (GB)

(21) Appl. No.: 18/861,414

(22) PCT Filed: May 4, 2023
(86) PCT No.: PCT/GB2023/051178

§ 371 Date: Oct. 29, 2024

(30) Foreign Application Priority Data
Jun. 20, 2022 (GB) 2209013.8

(51) Int. Cl. C01B 3/04; F01N 3/20

(52) U.S. Cl. CPC C01B 3/047; F01N 3/2066; C01B 2203/0277; C01B 2203/0816; C01B 2203/1058; C01B 2203/1614; C01B 2203/1628

(57) ABSTRACT

A process for cracking ammonia to form hydrogen is described comprising the steps of (i) passing ammonia through one or more catalyst-containing tubes in a furnace to crack the ammonia and form hydrogen, wherein the one or more tubes are heated by combustion of a fuel gas mixture to form a flue gas containing nitrogen oxides capable of reacting with ammonia in the flue gas to form ammonium nitrate, and (ii) cooling the flue gas to below 170° C., characterised by maintaining an amount of steam in the flue gas according to the following equation to prevent solid ammonium nitrate formation: (I) where, y_{H2O} is the mol % of steam in the flue gas, P*_{H2O} is the equilibrium vapor pressure of water in an aqueous solution of ammonium nitrate, and p is the minimum operating pressure of the flue gas.

This invention relates to a process for cracking ammonia, in particular cracking ammonia in a furnace heated by combustion of a fuel gas.

Ammonia may be cracked to form hydrogen. This reaction has been used for many years to provide hydrogen in ammonia plants to activate catalysts but is increasingly of interest as a means to provide hydrogen for power generation or other uses. The reaction may be depicted as follows:

2NH₃ [symbol] N₂+3H₂

The ammonia cracking reaction is endothermic and may usefully be achieved by passing ammonia over a suitable catalyst in externally heated catalyst-containing reaction tubes disposed in a furnace. Such furnaces are known, for example, for the steam reforming of natural gas or naphtha feedstocks. The furnace generally comprises a radiant section containing the reaction tubes where the fuel is combusted with air to provide the heat for the ammonia cracking reaction, and a downstream convection section, where flue gas formed by combustion is cooled, usually in indirect heat exchange with one or more feeds for the process in pre-heat coils.

The combustion of fuel gases, containing ammonia, with air in furnaces will form nitrogen oxides (NOₓ), particularly nitric oxide (NO) and nitrogen dioxide (NO₂).

In the event of an ammonia leak from the pre-heat coils, or incomplete combustion of ammonia when used as a component of the fuel or present for selective catalytic reduction, the presence of NH₃ and NOₓ and H₂O in the flue gas can result in the formation of ammonium nitrate or ammonium nitrite, which both pose an explosion risk, especially ammonium nitrite. Ammonium nitrite presents a particular hazard because it is highly unstable and so presents a risk of explosion. While NO is the predominantly formed gas during combustion of hydrogen/ammonia blends, NO₂ is also present and further formation of NO₂ is driven by the oxidation of NO, which is favoured as temperatures in the convection section of the furnace are reduced. The reactions to form ammonium nitrate may be depicted as follows:

2NO+O₂ [symbol] 2NO₂ (1)

3NO₂+H₂O [symbol] NO+2HNO₃ (2)

HNO₃+NH₃ [symbol] NH₄NO₃ (3)

Selective catalytic reduction (SCR) may be used in the convection section of the furnace, also referred to as the flue gas duct, to decompose NOx in the flue gas, however there is a need to manage ammonia cracking processes to further minimise the risk of ammonium nitrite and ammonium nitrate formation. Eliminating the conditions under which ammonium nitrate forms in this system safeguards against the formation of ammonium nitrite. We have realised that this may be provided by managing the steam partial pressure in the flue gas.

Accordingly, the invention provides a process for cracking ammonia to form hydrogen comprising the steps of (i) passing ammonia through one or more catalyst-containing tubes in a furnace to crack the ammonia and form hydrogen, wherein the one or more tubes are heated by combustion of a fuel gas mixture to form a flue gas containing nitrogen oxides capable of reacting with ammonia in the flue gas to form ammonium nitrate, and (ii) cooling the flue gas to below 170° C., characterised by maintaining an amount of steam in the flue gas according to the following equation to prevent solid ammonium nitrate formation:

$${y}_{{H}_{2} O} > \frac{{p}_{{H}_{2} O}^{*}}{P}$$

where,
y_{H}_{₂}_{O} is the mol % of steam in the flue gas,
p*_{H}_{₂}_{O} is the equilibrium vapor pressure of water in an aqueous solution of ammonium nitrate, and
P is the minimum operating pressure of the flue gas.

In the process according to the invention, the amount of steam should therefore be greater than the equilibrium vapour pressure of water in the aqueous ammonium nitrate solution resulting in the ammonium nitrate dissolving rather than depositing as a solid either inside the furnace, e.g. in the convection section or flue gas duct, or downstream of the furnace.

The steam content within the flue gas can be adjusted or managed by increasing the hydrogen content in the fuel gas and/or by addition of steam into the furnace via steam injection. To calculate the minimum steam partial pressure to prevent solid ammonium nitrate formation, the equilibrium vapor pressure of ammonia and the vapor pressure of water in an aqueous solution of ammonium nitrate may be determined.

The vapor pressure of water within an NH₄NO₃ solution has been measured and published at a range of temperatures. For example, the vapour pressures at 10-40° C. may be found the Kirk-Othmer Encyclopedia of Chemical Technology, Vol 2. 2003 in a section on Ammonium Compounds by in Weston, C., Papcun, J, Dery, M. A crystallisation curve is provided by Othmer et al in in paper entitled “Correlating vapor pressures and heats of solution for the ammonium nitrate-water system: An enthalpy-concentration diagram” published in the AIChE Journal, Vol 6, Issue 2. 1960. Pp 210-214, and a full set of data is published in a paper by Voorwinden, M. entitled “NH₄NO₂ Formation in Cooler Condenser” presented at the ANNA meeting October 2004, St. Louis, USA.

The range of interest for the present invention is up to 170° C., above which solid ammonium nitrate does not form. The following water vapour pressures have been used in the present invention.

| | Water Vapor |
|---|---|
| | Pressure in |
| | an ammonium |
| Temperature | nitrate/water |
| [° C.] | system [bar] |
| 0 | 0.005 |
| 10 | 0.009 |
| 20 | 0.015 |
| 30 | 0.025 |
| 40 | 0.038 |
| 50 | 0.059 |
| 60 | 0.084 |
| 70 | 0.117 |
| 80 | 0.159 |
| 90 | 0.208 |
| 100 | 0.259 |
| 110 | 0.285 |
| 120 | 0.294 |
| 130 | 0.294 |
| 140 | 0.285 |
| 150 | 0.233 |
| 160 | 0.117 |
| 170 | 0.000 |

It is also useful to determine the equilibrium vapor pressure of ammonia in a NOₓ—NH₃—HNO₃ mixture. This may be achieved as follows; from equations 2 and 3 above, the equilibrium constants can be defined as:

$${K}_{2} = {p}_{NO} \cdot {p}_{{HNO}_{3}}^{2} \qquad ( 4 )$$

$${K}_{3} = {p}_{{NH}_{3}} . {p}_{{HNO}_{3}} \qquad ( 5 )$$

Equilibrium constant K₂ can be derived from measurements by Forsythe et al in a paper entitled, “The Entropies of Nitric Acid and its Mono- and Tri-hydrates” published in J. Am. Chem. Soc. Vol. 64. 1942. Pp 48-61, giving the following equation (temperature measured in Kelvin):

$${K}_{2} = {e}^{( \frac{4735.6}{T} - 20.435 )} \qquad ( 6 )$$

K₂ can then be derived using equation 6 for the relevant operating temperature, and if the partial pressures of NO, NO₂ and H₂O are known, the partial pressure of nitric acid can be derived using equation 4.

Equilibrium constant K₃ can be derived from measurements by Brandner, J. D., et al. in a paper entitled, “Vapor Pressure of Ammonium Nitrate” published in J. Chem. Engineering Data, 7 (1962), pp. 227-228, giving the following equation:

$${K}_{3} = {10}^{⋀ ( 15.04 - \frac{9326}{T} )} \qquad ( 7 )$$

Once K₃ and pHNO₃ are calculated, the equilibrium vapor pressure of ammonia can be calculated using equation 5.

The temperature of the flue gas where ammonium nitrate solids may form is 170° C. or lower, for example in the range 10 to 170° C. The pressure of the flue gas may be in the range 0.8 to 1.2 bar.

Ammonia cracking furnaces are known and comprise a furnace box providing a radiant section to which a fuel gas and air are fed and where combustion using one or more burners creates radiant heat for heating one or more reaction tubes, containing an ammonia cracking catalyst. There may be tens or hundreds of tubes in the radiant section. The catalyst may be any ammonia cracking catalyst. Nickel catalyst and ruthenium catalysts may be used. Preferred catalysts are nickel catalysts. The catalyst may comprise 3 to 30% by weight nickel, preferably 8-20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCOR™ 27-2 available from Johnson Matthey PLC, which comprises 12% nickel, expressed as NiO, on a cylindrical pellet formed from a high surface area alumina support. The temperature of the ammonia feed at the inlet of the tubes may be in the range of 400 to 950° C. The temperature of the cracked gas exiting the tubes will influence the equilibrium position, and may be in the range of 500 to 950° C. Where nickel catalysts are used, the temperature exiting the tubes is preferably ≥700° C. The pressure inlet the tubes will be set by the flowsheet design and may be in the range 1 to 100 bar abs, preferably 10 to 90 bar abs. For example, where a pressure swing absorption unit is used as a hydrogen separation stage, the inlet pressure is may usefully be in the range of 31 to 51 bar absolute.

A fuel gas is combusted to generate the heat for the endothermic cracking reactions. The fuel gas comprises ammonia, such that combustion generates a flue gas comprising NO and/or NO₂ and steam. The fuel gas may contain 1 to 100% vol ammonia, i.e. the fuel gas may consist of ammonia, or may comprise ammonia in lower amounts, e.g. in the range 1 to 50% by volume, or 1 to 30% by volume. The ammonia-containing fuel gas may comprise a portion of the cracked ammonia gas, i.e. the fuel gas may comprise or consist of nitrogen, hydrogen and ammonia. Hydrogen is desirably present in the fuel gas to support combustion. Hydrocarbon gases, such as natural gas, may also 10 be used to supplement the fuel and provide the energy required for the ammonia cracking reaction. Water vapour may also be present in the fuel gas.

The combustion of the fuel gas creates a flue gas, which is conveyed from the radiant section of the furnace to a convection section of the furnace or flue gas duct, where the flue gas is cooled in indirect heat exchange. One or more stages of heat exchange may be provided in the convection section or flue gas duct.

In addition, it is desirable to include a selective catalytic reduction (SCR) unit within the flue gas duct. SCR units are known and generally comprise a honeycomb- or plate-supported catalyst that provides a low pressure drop. SCR catalysts are made from various porous ceramic materials, such as alumina, titania, zirconia, ceria or mixtures of these, and active catalytic components are usually either oxides of base metals (such as vanadium, molybdenum and tungsten), zeolites, or various precious metals, such as Pt and/or Pd. Base metal catalysts, such as vanadium and tungsten, lack high thermal durability, but are less expensive. Zeolite catalysts have the potential to operate at substantially higher temperature than base metal catalysts. Iron- and copper-exchanged zeolite urea SCRs may be used. The amount of platinum group metal is typically 5% by weight or less. A reductant, such as ammonia or urea solution, is added to the SCR catalyst to convert NOx in the flue gas to nitrogen and water. For example, SCR proceeds with anhydrous ammonia according to the following equations:

2NO+2NH₃+½O₂→2N₂+3H₂O (8)

NO₂+2NH₃+½O₂→3/2N₂+3H₂O (9)

NO+NO₂+2NH₃→2N₂+3H₂O (10)

The SCR catalyst may be operated at temperatures in the range 225-450° C.

NOₓ levels of up to 1500 ppmv may be present during combustion in the radiant section, reducing to <50 ppmv when passing through a SCR unit. Due to an excess of air, and potential for air ingress, oxygen will be present downstream of combustion.

The SCR unit is desirably downstream of a first heat recovery section. If desired a further heat recovery section may be provided downstream of the SCR unit to cool the flue gas to below 30° C. The flue gas at this point is particularly susceptible to solid ammonium nitrate formation when the temperature falls below 170° C. The management of the steam content therefore may therefore include addition of steam to the convection section of the furnace upstream or downstream of a SCR unit.

Calculations have shown that the minimum quantity of steam in the flue gas to inhibit solid ammonium nitrate formation under normal operating conditions is desirably about 19.9 mole % or higher. Possible malfunctions of the SCR unit or ammonia leaks increase the minimum amount of steam that desirably is present, which may, depending on the circumstances, be up to about 54.9 mole %, or higher.

The invention will now be further illustrated by reference to the FIGURE in which;

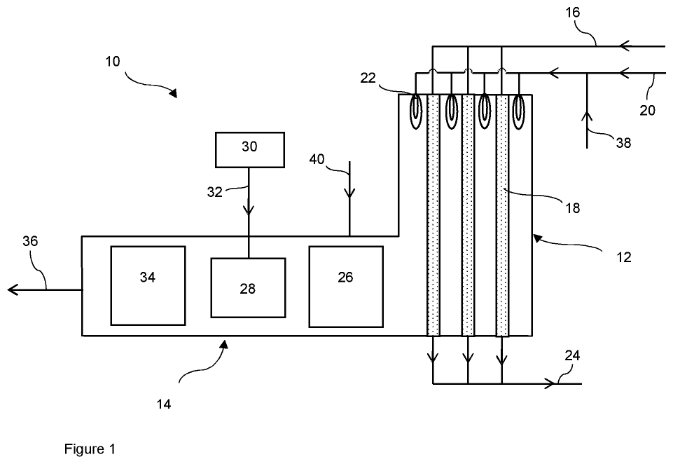

FIG. 1 is a depiction of an ammonia cracking furnace useful in the process of the present invention.

It will be understood by those skilled in the art that the drawings are diagrammatic and that further items of equipment such as feedstock drums, pumps, vacuum pumps, compressors, gas recycling compressors, temperature sensors, pressure sensors, pressure relief valves, control valves, flow controllers, level controllers, holding tanks, storage tanks and the like may be required in a commercial plant. Provision of such ancillary equipment forms no part of the present invention and is in accordance with conventional chemical engineering practice.

In FIG. 1, an ammonia cracking furnace 10 is depicted comprising a radiant section 12 and a convection section 14 comprising a flue gas duct. Ammonia is fed via line 16 to a plurality of nickel catalyst-containing reaction tubes 18 disposed within the radiant section 12. The tubes 18 are heated in the radiant section 12 by combustion of a fuel gas fed via line 20 to a plurality of burners 22. The fuel gas is combusted with air fed to the burners 22 via air supply lines (not shown). The fuel gas comprises ammonia and the combustion gases therefore contain nitrogen oxides, NOₓ. Ammonia is cracked in the reaction tubes 18 to form a gas mixture containing nitrogen and hydrogen and unreacted ammonia, which is collected from the tubes 18 via line 24 for further processing to recover the hydrogen.

The combustion gases containing NOₓ flow from the radiant section 12 to the convection section 14 flue gas duct and are cooled there in a first heat recovery unit 26, which includes steam generation, to generate a partially cooled flue gas. The partially cooled flue gas then passes within the flue gas duct to a downstream selective catalytic reduction (SCR) unit 26 containing a SCR catalyst that is fed with ammonia from a reductant storage unit 30 via line 32. The ammonia 32 reacts with nitrogen oxides in the partially cooled flue gas to form nitrogen and steam. The reaction is incomplete and trace amounts of NOx and NH₃ remain in the flue gas leaving the SCR unit 28. The flue gas leaving the SCR unit 28 is further cooled within the flue gas duct in a second heat recovery unit 34 to below 170° C. and recovered from the flue gas duct of the convection section 14 via line 36.

In order to prevent ammonium nitrate solids formation in the second heat recovery unit one or both of the following measures are adopted. A hydrogen stream is added via line 38 to the fuel gas 20 fed to the burners 22. Combustion of the hydrogen with air thereby generates additional steam in the flue gas leaving the radiant section 12 of the furnace 10. Alternatively or on addition, steam addition is made to the convection section 14 via line 40, preferably at or near the inlet of the convection section flue gas duct. The steam may be in part generated by the first heat recovery unit 26.

The invention will be further described by reference to the following calculated examples all of which were based on a process operated using the ammonia cracking furnace depicted in FIG. 1. The fuel gas contained 23.6% volume ammonia, 58.6% vol nitrogen, 17.6% vol hydrogen and 0.2% vol water vapour. The ammonia feed gas contained 0.14% vol water. The following reaction conditions were set:
Ammonia feed inlet temperature 550° C.
Cracked Gas Outlet temperature 700° C.
Ammonia content in the cracked gas ≤1.2 mole %
Flue gas duct inlet temperature 780° C.
SCR inlet temperature 370° C.
SCR outlet temperature 380° C.
NOx levels of 1500 ppmv during combustion of the ammonia fuel gas, reducing to 50 ppmv when passing through the SCR.

### Example 1: Normal Operation

In normal operation, the risk of ammonium nitrate formation downstream of the SCR unit 28 would occur where residual NOₓ and a low level of slipped NH₃ were present. Current emission limits require NOₓ levels below 50 ppmv and NH₃ levels below 5 ppmv. These levels were used to determine the steam partial pressures required. The operating pressure of the flue gas was 0.8 to 1.1 bara. In addition, because the degree of oxidation of NOₓ also may impact on the steam requirements, an oxidation ratio

$$( defined as \frac{{p}_{{NO}_{2}}}{{P}_{{NO}_{x}}} )$$

was investigated at 0.1, 0.5 and 0.9. While NO₂ does not form a majority of the NOₓ, to give the largest safety margin within the calculation, an oxidation ratio of 0.9 was assumed. Accordingly, assuming an exit pressure from the duct of 0.8 bar, and an oxidation ratio of 0.9, ammonium nitrate formation was prevented during normal operation by having a steam content in the flue gas of 19.9 mol %, or higher.

### Example 2: SCR Malfunction

In this scenario a SCR malfunction has not reduced the NOₓ level from the 1500 ppmv produced in the radiant section. In the case of the SCR malfunctioning, and ammonia continuing to be fed into the duct through the SCR vessel, NOₓ levels would remain at 1500 ppmv and NH₃ levels would be around 1000 ppmv. Then, to avoid solid ammonium nitrate formation, the required steam content in the flue gas would be higher, ranging from 32.4 mol % (with an oxidation ratio of 0.1) to 36.8 mol % (with an oxidation ratio of 0.9), assuming an exit pressure from the duct of 0.8 bar a.

### Example 3: Ammonia Leak

In this scenario an ammonia leak into the flue gas duct (with SCR functioning) was investigated. In this case, the SCR was functioning as required to maintain NOₓ levels <50 ppmv. However, a leak within the duct coils introduced ammonia into the flue gas. The worst case, in which all ammonia leaks into the duct, would result in NH₃ levels reaching 33 mol %. Then, to prevent solid ammonium nitrate formation, the steam content in the flue gas, downstream of the ammonia leak, would need to be at or above 36.8 mol % (assuming an exit pressure from the duct of 0.8 bar abs. with an oxidation ratio in the range of 0.1 to 0.9).

### Example 4: Ammonia Leak and SCR Malfunction

In this scenario an ammonia leak into the flue gas duct (with SCR not functioning) was investigated. In this operating case, the SCR in non-functioning and NOₓ levels remain at 1500 ppmv. However, a leak within the duct coils has introduced ammonia into the flue gas. The worst case, in which all ammonia leaks into the duct, would result in NH₃ levels reaching 33 mol %. The steam content required to prevent solid ammonium nitrate formation varies depending on the extent of the leak. For small leaks resulting in ammonia levels ≤1 mol %, having a steam content in the flue gas (prior to ammonia leak) of 37.2 mol % would be sufficient to prevent the risk of solid ammonium nitrate formation. The steam content, downstream of the ammonia leak, should be at or above 36.8 mol %.

Assuming the lowest pressure in the duct is 0.8 bar absolute and using an oxidation ratio of 0.9, the following steam content within the flue gas to prevent the risk of solid ammonium nitrate formation was calculated:

| | | | NOₓ | Steam |
|---|---|---|---|---|
| Operating | NH₃ | | content | content |
| Regime | content | | [ppmv] | [mol %] |
| Normal | 5 | ppmv | 50 | ≥19.9% |
| operation | | | | |
| (with SCR) | | | | |
| SCR | 1000 | ppmv | 1500 | ≥36.8% |
| malfunction | | | | |
| NH₃ leak | 1 | mol % | 50 | ≥36.8% |
| [SCR operating] | | | | (≥37.2% upstream |
| | | | | of leak) |
| | 5 | mol % | 50 | ≥36.8% |
| | | | | (≥38.7% upstream |
| | | | | of leak) |
| | 10 | mol % | 50 | ≥36.8% |
| | | | | (≥40.9% upstream |
| | | | | of leak) |
| | 33 | mol % | 50 | ≥36.8% |
| | | | | (≥54.9% upstream |
| | | | | of leak) |
| NH₃ leak | 1 | mol % | 1500 | ≥36.8% |
| [SCR malfunctioning] | | | | (≥37.2% upstream |
| | | | | of leak) |
| | 5 | mol % | 1500 | ≥36.8% |
| | | | | (≥38.7% upstream |
| | | | | of leak) |
| | 10 | mol % | 1500 | ≥36.8% |
| | | | | (≥40.9% upstream |
| | | | | of leak) |
| | 33 | mol % | 1500 | ≥36.8% |
| | | | | (≥54.9% upstream |
| | | | | of leak) |

1. A process for cracking ammonia to form hydrogen comprising the steps of (i) passing ammonia through one or more catalyst-containing tubes in a furnace to crack the ammonia and form hydrogen, wherein the one or more tubes are heated by combustion of a fuel gas mixture to form a flue gas containing nitrogen oxides capable of reacting with ammonia in the flue gas to form ammonium nitrate, and (ii) cooling the flue gas to below 170° C., wherein maintaining an amount of steam in the flue gas according to the following equation to prevent solid ammonium nitrate formation:
$${y}_{{H}_{2} O} > \frac{{p}_{{H}_{2} O}^{*}}{P}$$
where,
y_{H}_{₂}_{O} is the mol % of steam in the flue gas,
p*_{H}_{₂}_{O} is the equilibrium vapor pressure of water in an aqueous solution of ammonium nitrate, and
P is the minimum operating pressure of the flue gas.

2. The process according to claim 1, wherein the furnace comprises a radiant section in which the catalyst-containing tubes are heated, and a convection section downstream of the radiant section in which the flue gas is cooled to below 170° C.

3. The process according to claim 1, wherein the ammonia cracking catalyst is a nickel catalyst or a ruthenium catalyst, preferably a nickel catalyst.

4. The process according to claim 1, wherein the ammonia is fed to the catalyst-containing tubes at a temperature in the range 400 to 950° C.

5. The process according to claim 1, wherein the ammonia is fed to the catalyst containing tubes at a pressure in the range of 1 to 100 bar abs, preferably 10 to 90 bar abs.

6. The process according to claim 1, wherein the fuel gas mixture contains 1 to 100% or 1 to 50% by volume of ammonia.

7. The process according to claim 1, wherein the fuel gas comprises nitrogen, hydrogen and 1 to 50% by volume ammonia.

8. The process according to claim 2, wherein a selective catalytic reduction unit is installed in the convection section to reduce the nitrogen oxides content of the flue gas, preferably wherein a selective catalytic reduction unit is installed in the convection section downstream of a first heat recovery unit that cools the flue gas to an inlet temperature for the selective catalytic reduction unit.

9. The process according to claim 8, wherein the selective catalytic reduction section is located upstream of a second heat recovery unit that cools the flue gas, after it has passed through the selective catalytic reduction unit, to below 170° C.

10. The process according to claim 1, wherein hydrogen is added to the fuel gas mixture to maintain the amount of steam in the flue gas to prevent solid ammonium nitrate formation.

11. The process according to claim 1, wherein the steam is added to the flue gas to prevent solid ammonium nitrate formation.

12. The process according to claim 11, wherein steam is added to the flue gas upstream of a selective catalytic reduction unit.
